(19) United States
(12) Patent Application Publication
(10) Pub. No.: US 2005/0054116 A1
(43) Pub. Date: Mar. 10, 2005

(54) Method of manufacturing and evaluating sensor coatings and the sensors derived therefrom

(76) Inventors: Radislav A. Potyrailo, Niskayuna, NY (US); Joseph R. Wetzel, Leesburg, VA (US)

Correspondence Address: CANTOR COLBURN, LLP, 55 GRIFFIN ROAD SOUTH, BLOOMFIELD, CT, 06002, US

(21) Appl. No.: 10/656,594

(22) Filed: Sep. 5, 2003

(51) Int. Cl. G01N 1/10

(52) U.S. Cl. 436/180; 422/68.1; 257/414; 438/49; 422/100

(57) ABSTRACT

A system for creating a combinatorial coating sensor library comprises a delivery mechanism in fluid communication with a source of organic polymer reactants and a substrate having at least one delivery area; a reaction source operative to apply at least one reactive environment to the delivery area; and a controller in communication with the delivery mechanism in a manner effective to apply a plurality of organic reactants to the substrate, and further wherein the controller is in communication with the reaction source in a manner effective to react at least one of the plurality of organic reactants on the substrate into an organic block copolymer coating.

### BACKGROUND

This disclosure relates to method of manufacturing and evaluating sensor coatings and the sensors derived therefrom.

Sensors for detecting analytes are generally manufactured from inorganic materials such as metal oxides, sol-gels, ceramics derived from sol-gels, thin metal films, and the like, because of their ability to detect analytes in the parts per billion range. However, these inorganic materials are brittle, cannot be adequately formed into monoliths, are easily attacked by oxygen in air, and require stable temperature conditions for their operation. In order to compensate for these limitations, these materials are often encapsulated in a protective sample holder.

Organic polymers, on the other hand, are used in a wide variety of applications because of their ability to impart advantageous physical characteristics such as light weight, ductility, high impact strength, and the like, to the application. Organic polymers are rarely utilized used in sensors capable of selectively detecting analytes in the parts per billion range because of their lack of sensitivity (i.e., they can only detect in the parts per million range) and their lack of selectivity. There is therefore a desire to manufacture sensors that combine advantageous physical properties with an ability to detect the presence of analytes in the parts per billion range.

### BRIEF DESCRIPTION OF THE INVENTION

A system for creating a combinatorial coating sensor library comprises a delivery mechanism in fluid communication with a source of organic polymer reactants and a substrate having at least one delivery area; a reaction source operative to apply at least one reactive environment to the delivery area; and a controller in communication with the delivery mechanism in a manner effective to apply a plurality of organic reactants to the substrate, and further wherein the controller is in communication with the reaction source in a manner effective to react at least one of the plurality of organic reactants on the substrate into an organic block copolymer coating.

A method for creating a sensor array comprises delivering a plurality of organic reactants in a quantity effective to form a block copolymer to at least one predefined region positioned within a delivery area of a substrate; reacting the plurality of organic reactants in at least one of the predefined regions to form an organic block copolymer coating, and wherein the organic block copolymer coating in conjunction with at least the substrate is capable of detecting the presence of an analyte in amounts of less than 1 part per million parts.

A sensor comprises an organic block copolymer coating disposed upon a detection device; wherein the detection device comprises an acoustic wave device or a quartz crystal microbalance device and further wherein the organic block copolymer coating has a partition coefficient of greater than or equal to about 105 towards at least one analyte.

### BRIEF DESCRIPTION OF THE DRAWING

FIG. 1 is a schematic representation of a system for the deposition, synthesis and evaluation of organic block copolymers that are used as coatings in sensors;

FIG. 2 represents a perspective view of a coating library generated by the combinatorial system;

FIG. 3 is a cross-sectional side view of one embodiment of the system of FIG. 1, utilizing a one-dimensional spin-coating method;

FIG. 4 is a cross-sectional side view of another embodiment of the system of FIG. 1, utilizing a two-dimensional spin-coating method;

FIG. 5 is a perspective view of a further embodiment of the system of FIG. 1, utilizing a dip-coating method;

FIG. 6 depicts a table showing the dianhydrides along with their respective values for the octanol-water partition coefficients and their molar refractivity;

FIG. 7 depicts a table showing the variables used in developing the polyimide-polysiloxane block copolymers using a 7×4×2 combinatorial array;

FIG. 8 is a graphical representation of the dynamic response of sensor 1 (left) and sensor 2 (right) upon exposure to 106 parts per million (ppm) of pentachloroethylene (PCE) and dry nitrogen.

FIG. 9 is a graphical representation of the dynamic response of sensor 1 (left) and sensor 2 (right) upon exposure to 103 ppm of trichloroethylene (TCE) and dry nitrogen.

FIG. 10 is a graphical representation of the dynamic response of sensor 1 (left) and sensor 2 (right) upon exposure to 100 ppm of toluene and dry nitrogen.

FIG. 11 is a graphical representation of the dynamic response of sensor 1 (left) and sensor 2 (right) upon exposure to air of 37% relative humidity and dry nitrogen.

FIG. 12 is a bar plot depicting the response of a sensor array toward different vapors by comparison with the response to toluene; and

FIG. 13 is a plot showing the selectivity toward toluene, trichloroethylene (TCE), and pentachloroethylene (PCE) in response of sensor array towards different vapors using principal components analysis (PCA).

FIG. 14 is a graphical representation of the dynamic response of 6FDA-mPDA-PDMS organic block copolymer produced using combinatorial approach upon exposure to 10 ppm of TCE (1) and 10 ppm of PCE (2) and dry nitrogen.

FIG. 15 is a graphical representation of the partition coefficients of a control sensor material (1) and the 6FDA-mPDA-PDMS organic block copolymer (2) for different analyte vapors such as TCE, PCE and cis-dichloroethylene (cis-DCE).

FIG. 16 is a graphical representation of the partition coefficients of a control sensor material (1) and 6FDA-mPDA-PDMS organic block copolymer (2) for different analyte vapors such as carbon tetrachloride (Carb Tet), chloroform (Chlor) and toluene (Tol).

FIG. 17 is a graphical representation of the partition coefficients relative to the partition coefficient of TCE for the control sensor material (1) and 6FDA-mPDA-PDMS organic block copolymer (2) for different analyte vapors such as TCE, PCE, toluene, cis-DCE, chloroform, and carbon tetrachloride.

### DETAILED DESCRIPTION OF PREFERRED EMBODIMENTS

Disclosed herein are organic block copolymers that are used as coatings in chemical sensors to facilitate the detection of a wide variety of analytes. These organic block copolymers generally belong to a family of block copolymers whose partition coefficients can be systematically modified using a combinatorial library for purposes of detecting a specific analyte. The partition coefficient may generally be increased or decreased for a specific analyte by employing different oligomeric species to form the organic block copolymer backbone and also by employing different functional groups or substituents along the organic block copolymer backbone.

Disclosed herein too, are methods for manufacturing organic polymers wherein the partition coefficient (and hence the sensitivity and selectivity) of the organic block copolymer with respect to a single analyte or a group of analytes is systematically varied by employing a combinatorial library. In another embodiment, the combinatorial library in conjunction with combinatorial methods may be advantageously be used to optimize the partition coefficient for analyte detection.

The aforementioned combinatorial method of determining the ability of organic block copolymers to be used as coatings in a sensor, advantageously permits the simultaneous large scale testing of a wide variety of block copolymers. It also permits the development of sensors for a wide variety of commercial applications including screening of volatiles during studies of polymer degradation, monitoring of industrial pollutants, environmental monitoring of trace levels of analytes, and the like.

The partition coefficient, K, is a thermodynamic parameter that corresponds to an equilibrium distribution of sorbed analyte molecules between the gas phase and the polymeric film. The partition coefficient is the ratio of a concentration of an analyte in the polymeric film, C_{F}, to the concentration of the analyte outside of the film, C_{V}. The partition coefficient K is determined according to Equation (1)
K=C_{F}/C_{V} (1).

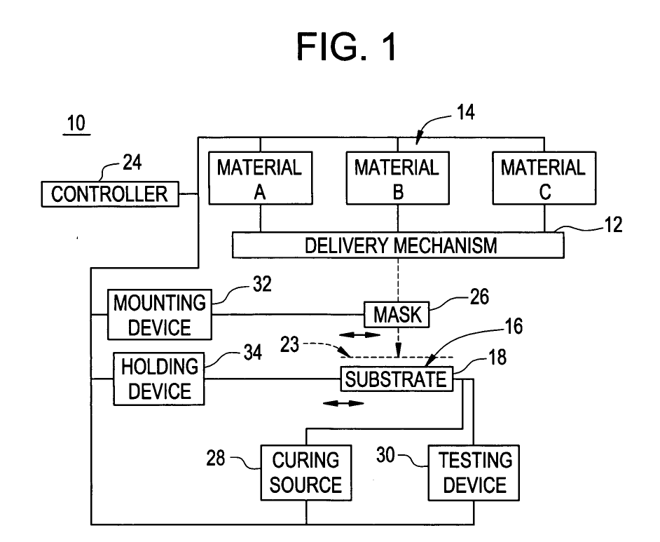

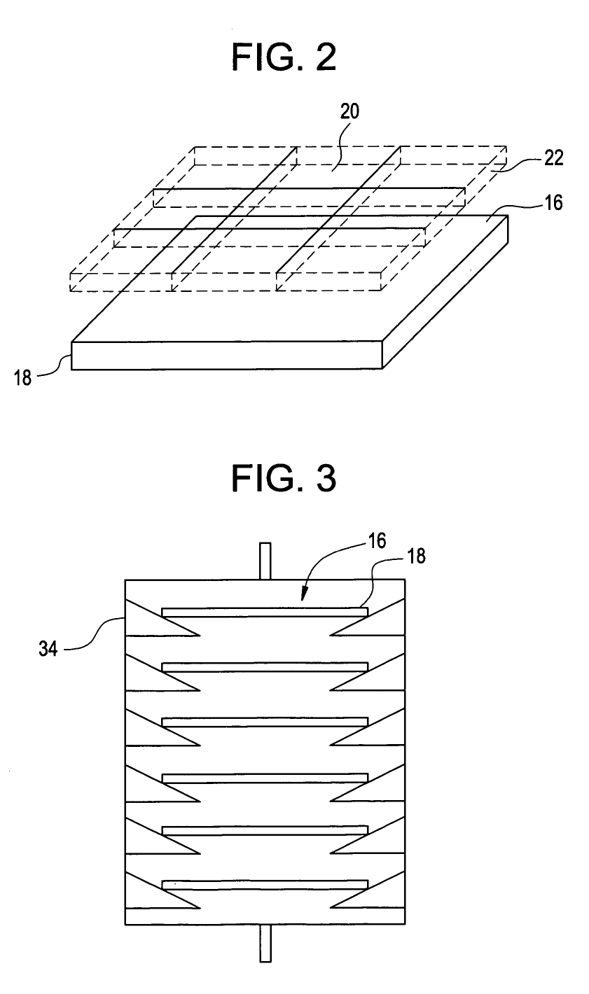

As stated above, combinatorial methods are used for synthesizing and testing the organic block copolymers for use as coatings in sensors. FIG. 1 is a schematic representation of a system for the deposition and synthesis of the block copolymer while FIG. 2 represents a perspective view of a coating library generated by the combinatorial system of FIG. 1. Referring to FIGS. 1 and 2, a system 10 for making an array of coated materials that form a coating library 11 includes a delivery mechanism 12 for delivering the organic reactants 14 onto a surface 16 of a substrate 18 to form a coating 20. The organic reactants comprise reactive monomers, oligomers, polymers, and the like, in stoichiometric quantities effective to form a block copolymer. The substrate surface 16 includes a plurality of predefined regions 22 that are positioned within a delivery area 23. The delivery mechanism 12 is positioned to deliver the organic reactants 14 to the delivery area 23. Optionally, a mixer combines the organic reactants 14 to form a mixture or combination of the organic reactants 14, with a controller 24 controlling the selection, quantity, and sequence of delivery of each of the organic reactants 14 to the mixer such that the composition of the coating 20 may be varied, either incrementally or continuously, between each of the plurality of predefined regions 22 of the substrate surface 16 to form a coating library 11. Each of the plurality of predefined regions 22 is eventually coated with organic polymer coating having a predefined composition. The organic polymer coating may initially contain an unreacted single layer coating of the organic reactants 14. Optionally, the organic polymer coatings may also initially comprise a multi-layer coating, where each layer contains only one of the organic reactants 14, or a multi-layer coating, where each layer is a combination of the organic reactants 14. It may also be desirable to have successive layers wherein a first layer contains only one of the organic reactants, while the second adjacent layer in intimate contact with the first layer contains a combination of the organic reactants 14.

Additionally, the system 10 may include a mask 26 in communication with the controller 24 to permit the delivery of the organic reactants 14 to different combinations of the plurality of predefined regions 22 of the substrate surface 16. The system 10 may also include a source of energy (curing source or reaction source) 28 for reacting the organic reactants 14, either as they are being delivered onto the substrate surface 16 or once they have been deposited on the substrate 18. Further, the system 10 may include a testing device 30 for performing analytical tests on the coated substrate 18 or coating library 11 to determine the properties or characteristics of each of the predefined coatings. The mask 26 may be secured by a mounting device 32, which optionally may movably position the mask 26 within the system 10. Similarly, the substrate 18 may be secured by a holding device 34, which preferably movably positions the substrate 18 within the system 10.

The delivery mechanism 12 may be a single device or it may be a plurality of individual devices, each delivering the organic reactants 14 onto the surface 16 of the substrate 18. The delivery mechanism may also be used to deliver optional solvents, fluorescent molecules, stabilizers, anti-oxidants, and the like, to the delivery area. The position of the delivery mechanism 12 may be fixed within the system 10 relative to the delivery area 23 or it may be movable relative to the delivery area 23. Preferably, the delivery mechanism 12 projects the organic reactants 14 to the delivery area 23 in a liquid form. Suitable examples of a delivery mechanism 12 include: a spray nozzle or gun of any type, such as an air, airless, thermal, ultrasonic, or hydraulic force spray nozzle or gun; a die/scraper casting head; an electron-beam evaporator; a sputtering device; a chemical vapor deposition device; an ink jet print head; a draw-down device, such as a wire-wound rod or a doctor-blade; and a linear coating head. The linear coating head may, for example, include one or more coating applicators, each having a supply inlet in fluid communication with at least one of the organic reactants 14 and each defining an elongate distribution channel with a length corresponding to a width of the substrate 18. The linear coating head is preferably positioned at a suitable distance adjacent to the surface 16 of the substrate 18 to dispense a uniform thickness of the organic reactants 14, or a combination thereof, onto the substrate 18.

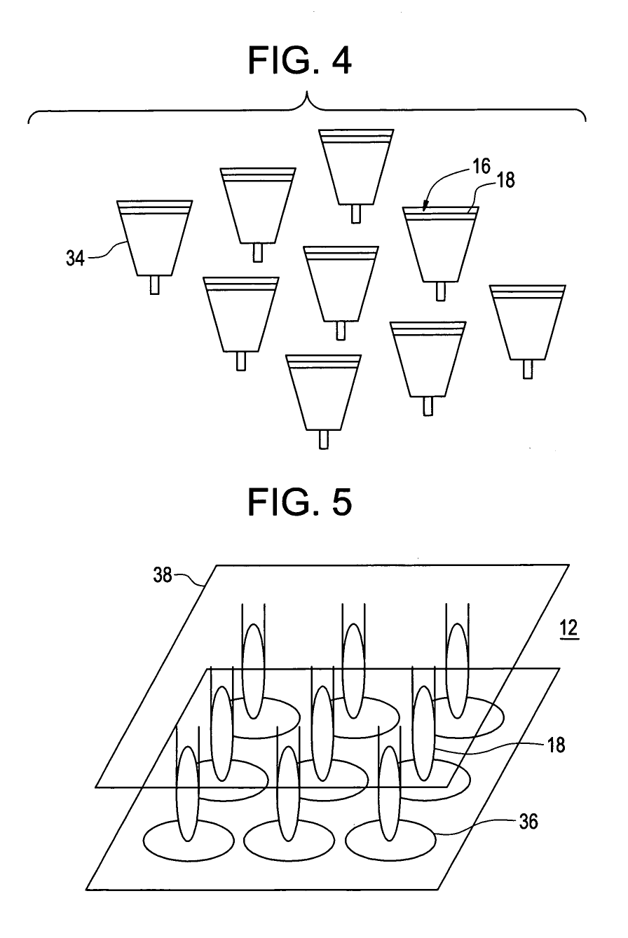

In one embodiment, the delivery mechanism 12 may also include a plurality of conventional liquid-handling devices such as the Quadra 96 Model 230 Liquid Delivery System commercially available from Tomtec in Orange, Conn. The liquid-handling devices, placed at predetermined positions adjacent to the surface 16 of one or more spinning substrates 18, delivers the organic reactants 14, or combinations thereof, to the substrate(s) 18. The spinning substrate(s) 18, and the associated holding device 34 may be arranged in, for example, a one-dimensional array (see FIG. 3) or a two-dimensional array (see FIG. 4).

In another embodiment, depicted in FIG. 5, the delivery mechanism 12 may include a plurality of wells 36 or other suitable containers in which the organic reactants 14, or combinations thereof, may be disposed. Liquids of the same or different compositions may be disposed within the plurality of wells 36 using, for example, a liquid-handling device. A plurality of substrates 18, each held by a substrate holder, are arranged vertically and immersed in the corresponding wells 36. Upon removal of the substrate array 38, each of the plurality of substrates 18 is dip-coated with a predetermined coating. This method is useful for the coating of acoustic wave transducers used to measure variations in acoustic wave parameters as the amount of material deposited on each device or the viscoelastic properties of each coating vary. Each of the plurality of acoustic wave transducers may have a first acoustic wave parameter and a second acoustic wave parameter, the first acoustic wave parameter corresponding to a first amount of coating or viscoelastic property of the coating layer, the second acoustic wave parameter corresponding to a second amount of coating or viscoelastic property of the coating layer.

Referring again to FIGS. 1 and 2, the organic reactants 14 are generally in the fluid state or the melt state. Suitable examples of said materials 14 include polymeric materials, oligomeric materials, and small molecules, where the small molecules may be individual monomers that react to form a coating. The organic polymers will be discussed in detail below.

The organic reactants 14 are combined on the surface 16 of the substrate 18 in a manner such that multiple organic materials are combined to form the coating 20. By providing these various combinations of the organic reactants 14, the interaction of various combinations of analytes with the organic block copolymers may be determined through the use of the testing device 30. Each member (organic block copolymer) of the array of coatings is distinguishable from the others based upon its location. Further, each member of the array of coatings may be processed under the same conditions and analyzed to determine its performance relative to a desired functional or useful property, and then compared with each of the other members of the array of coatings to determine its relative utility. Alternatively, each member of the array of coatings may be processed under different conditions and the processing methods may be analyzed to determine their performance relative to a desired functional or useful property, and then compared with each other to determine their relative utility.

Each of the plurality of predefined regions 22 is a fixed area on the surface 16 of the substrate 18 for receiving one or a combination of the organic reactants 14 to form a coating 20. Each of the predefined regions 22 may have any shape sufficient for receiving and analyzing the coating 20 deposited thereon, such as square, rectangular, arcuate, circular, elliptical, or the like, or combinations thereof.

Each of the predefined regions 22 typically has an area in the range of about 0.01 square millimeter (mm²) to about 100 square centimeters (cm²). Within this range, and area of greater than or equal to about 1 mm², preferably greater than or equal to about 10 cm² may be used. Also desirable within this range is an area of less than or equal to about 90 mm², preferably less than or equal to about 50 mm², and more preferably less than or equal to about 10 mm² may be used.

The substrate 18 is a rigid or semi-rigid material suitable for receiving and supporting the organic reactants 14. The substrate 18 has at least one substantially flat surface 16, or surface otherwise capable of receiving the organic reactants 14, which includes the plurality of predefined regions 22. This surface 16, optionally, may have raised portions that serve as barriers to physically separate each of the plurality of predefined regions 22. The substrate 18 may be of any size and shape, but preferably is in an elongated shape, such as in a tape, film, web, or roll.

The substrate 18 may also alternatively be in a disk or plate, having a spherical shape. The surface 16 of the substrate 18, corresponding to the delivery area 23, typically has a total area in the range of about 1 mm² to about 1 square meter (m²). Within this range, the total area of the delivery area is preferably greater than or equal to about 50 mm², and more preferably greater than or equal to about 750 cm². Also desirable within this range is an area of less than or equal to about 500 cm², and more preferably less than or equal to about 1 cm².

The substrate may have detection capabilities suitable for the detection of analytes. Common examples of sensors which can be used as substrates are surface acoustic wave (SAW) sensors; quartz microbalance sensors; conductive composites; chemi-resistors; metal oxide gas sensors, such as tin oxide gas sensors; organic gas sensors; metal oxide field effect transistors (MOSFET); piezoelectric devices; infrared sensors; sintered metal oxide sensors; palladium (Pd)—gate MOSFETs; metal FET structures; metal oxide sensors, such as a Tuguchi gas sensors; phthalocyanine sensors; electrochemical cells; conducting polymer sensors; catalytic gas sensors; organic semiconducting gas sensors; solid electrolyte gas sensors; piezoelectric quartz crystal sensors; dye-impregnated polymer films on fiber optic detectors; polymer-coated micromirrors; electrochemical gas detectors; chemically sensitive field-effect transistors; carbon black-polymer composite chemiresistors; micro-electro-mechanical system devices; and micro-opto-electro-mechanical system devices and Langmuir-Blodgett film sensors.

Exemplary substrates having detection capabilities are acoustic wave device or a quartz crystal microbalance (QCM). If the substrate is an acoustic wave device, mechanical oscillations generated during the sorption of the analyte are propagated in substantially up-and-down undulations at a radio frequency (RF) along the surface of a thin, piezoelectric element. Acoustic wave devices that do not have a piezoelectric element are also commerically available. Acoustic wave devices are commercially available in a number of configurations. These devices are commerically available in a number of configurations such as thickness-shear mode (TSM), surface acoustic wave (SAW), acoustic plate mode (APM), flexural plate wave (FPW), and surface transverse wave (STW) devices.

The operating frequencies of these acoustic-wave devices that use piezoelectric elements may be in the following approximate ranges: thickness-shear mode, 0.1 to 70 MHz; surface acoustic wave, 30 to 10000 MHz; acoustic plate mode, 20 to 500 MHz; flexural plate wave, 0.01 to 10 MHz; surface transverse wave, 100 to 1000 MHz; and thin-rod acoustic wave, 0.2 to 1 MHz.

Non-piezoelectric acoustic wave devices can be also utilized. A thin-rod acoustic wave device is an example of a non-piezoelectric acoustic wave device. The thin-rod acoustic wave device can be operated at low frequencies of about 200 kHz. Other acoustic wave devices can be also made of non-piezoelectric materials. These devices include cantilevers, torsion resonators, tuning forks, bimorphs (i.e., a two-pronged tuning fork), unimorphs (i.e., a single pronged tuning fork), membrane resonators, or the like. For the non-piezoelectric acoustic-wave devices, such as the bimorphs, unimorphs, cantilevers, torsion resonators, tuning forks, membrane resonators, or the like, the operating frequencies are in the range of about 1 Hz to 1 MHz.

If the substrate comprises a QCM as a sensor substrate, the sensor operates by propagating mechanical oscillations perpendicularly between parallel faces of a thin, quartz-crystal piezoelectric element. The quartz crystals generally oscillate in a thickness shear mode at a frequency of about 0.1 to 70 MHz.

The organic reactants 14 are deposited on the surface 16 of the substrate 18. These organic reactants 14 may remain as separate homogenous materials, or they may interact, react, diffuse, mix, or otherwise combine to form a new homogeneous material, a mixture, a composite, or a blend. In general, a coating 20 has a lateral measure, i.e. a measured length across the surface 16 of the substrate 18, much greater than a thickness, i.e. a measure of the coating 20 normal to the surface 16 of the substrate 18. If the coating is a multilayered coating, preferably, each layer of the coating 20 is a thin-film layer. The coating 20 may vary in composition, preferably in an incremental or continuous manner, from one predefined region 22 to another, to thereby form an array of coatings that define the plurality of predefined coatings of the coating library 11.

The substrate 18 may be secured within the system 10 and positioned in the delivery area 23 by the holding device 34. The holding device 34 may movably position the substrate 18 within the system 10. Preferably, the holding device 34 may movably position the substrate 18 at a substantially constant rate. For example, for a substrate 18 in the form of an elongated tape, web, or roll, the holding device 34 may include a tape pay-out device and a tape take-up device that are both rotatable and which support the tape, possibly in combination with rollers, in the delivery area 23. In another example, the holding device 34 may be a stage on which the substrate 18 is placed and secured, where the stage is connected to a motor or other actuator-type device that controls the position and movement of the stage relative to the delivery area 23. As such, the controller 24 may control the movement of the holding device 34 to determine which of the plurality of predefined regions 22 of the surface 16 of the substrate 18 receive the organic reactants 14. For example, the controller 24 may move the holding device 34 such that a certain predetermined region of the plurality of predefined regions 22 are outside of the delivery area 23 and therefore do not receive the organic reactants 14.

The delivery area 23 is an area at a fixed position within the system 10. The delivery area 23 may be of any shape and size and typically, but not necessarily, substantially corresponds in shape and size to the plurality of predefined regions 22 of the surface 16 of the substrate 18. However, the plurality of predefined regions 22 of the surface 16 of the substrate 18 may be much larger or much smaller than the delivery area 23. The fixed positioning of the delivery area 23 provides a known, constant locale for the system 10 to deliver the organic reactants 14 onto the surface 16 of the substrate 18.

The controller 24 is a computer system having inputs, outputs, a memory, and a processor for receiving, sending, storing, and processing signals and data to operate, monitor, record, and otherwise functionally control the operation of the system 10. The controller 24 includes a computer system having an interface board for integrating all of the components of the system 10 and a motion controller for controlling the movements of the mask 26 and substrate 18. The controller 24 may include a keyboard and a mouse for inputting data and commands, a video display for displaying information, and a printer for printing information. The controller 24 may include software, hardware, firmware, and other similar components and circuitry for operating the system 10. The controller 24 may be a single device, or it may be a plurality of devices working in concert.

The controller 24 is preferably in communication with all of the other components of the system 10, including the organic reactants 14, the delivery mechanism 12, the substrate 18, the mask 26, the reaction source 28, the testing device 30, the mounting device 32, and the holding device 34, to coordinate the operations of the system 10. For example, the controller 24 may control the selection, quantity, and sequence of delivery of each of the organic reactants 14 to a mixer such that the composition of the coating 20 may be varied, either incrementally or continuously, between each of the plurality of predefined regions 22 of the substrate surface 16. The controller 24 may also control the delivery of the organic reactants 14 onto the substrate 18, recording the exact combination of materials 14 that make up the coating 20 at each predefined region 22. By controlling the delivery, the controller 24 may control one or more of the material volume, the organic reactants 14, the coating speed, the spacing between the delivery mechanism 12 and the substrate 18, and the like.

Further, the controller 24 controls, synchronizes, combines, and records the delivery and reacting of the organic reactants 14, the testing of the coating library 11, and the analysis of the test results. The mask 26 is a material having one or more patterns of open areas and blocked areas, where the open areas allow delivery of the organic reactants 14 and/or a reactive monomer onto the substrate 18 and the blocked areas prohibit the delivery. The mask may have any desired shape.

The mask 26 is utilized to define the spatial variation of materials or processing conditions in the coating library. In a binary masking system, for example, the mask 26 includes a plurality of patterns that are sequentially arranged to allow delivery to alternating half areas on the surface 16 of the substrate 18. The mask 26 may be formed of a rigid or semi-rigid material, or the mask 26 may be a chemical formed on the surface 16 of the substrate 18. Preferably, the material of the mask 26 insures that the mask 26 is as flat as possible and resists bending and/or folding. Suitable examples of mask materials include: silicon, silicon oxide, and glass for rigid or relatively non-bendable materials; plastics, metals, and alloys for semi-rigid or relatively bendable materials in the form of sheets, films, or foils; and lithographic-polyacrylate (“PMMA”) and other chemical materials that form positive and negative chemical masks.

The mask 26 may be secured within the system 10 and positioned relative to the delivery area 23 by the mounting device 32. The mounting device 32 may movably position the mask 26. For example, for a mask 26 in the form of an elongated semi-rigid material having a plurality of patterns, the mounting device 32 may include a tape pay-out device and a tape take-up device that are both rotatable and that support the tape, possibly in combination with rollers, relative to the delivery area 23. In another example, for a mask 26 in the form of a rigid material, the mounting device 32 may be a platform or other supporting structure connected to a motor or other actuator-type device that controls the position of the platform and mask 26 relative to the delivery area 23. This allows one pattern or a number of patterns to be utilized to mask different predefined regions 22 of the substrate 18 by movement of the mask 26. In general, the controller 24 may control the movement of the mounting device 32 to control the predefined regions 22 onto which the organic reactants 14, or combinations thereof, are delivered.

The reaction source 28 provides a reactive environment for the organic reactants 14 thereby promoting a reaction to form the organic block copolymer coating. For example, the reaction may be a polymerization reaction, a cross-linking reaction, a small molecule reaction, an inorganic phase reaction, and other similar reactions appropriate for the organic reactants 14. The reaction source 28 accomplishes this by delivering a reaction initiator, a curing initiator, a source of energy or a combination of at least one of the foregoing to the plurality of predefined regions 22. Suitable examples of a reaction source 28 are ultraviolet (UV) radiation, infrared (IR) radiation, thermal radiation, microwave radiation, visible radiation, narrow-wavelength radiation, laser light, convectional and conductional heating, humidity, peroxides, catalysts, or the like, or combinations comprising at least one of the foregoing reaction sources. Suitable examples of a reaction source 28 include, for example, a heating device in communication with the substrate 18, a radiation device in communication with the delivered or deposited materials 14, a microwave device, a plasma device, and combinations thereof.

The organic block copolymer used in the coating has the general structure in formula shown below 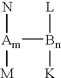
where A represents a first segment comprising an organic polymer, B represents a second segment comprising an organic polymer, K, L, M and N may be the same or different and represent respective functional groups, m and n represent the degree of polymerization respectively. The first segment of the organic block copolymer has a glass transition temperature (T_{g}) greater than or equal to about room temperature and is covalently bonded with the second segment of the organic block copolymer having a T_{g} that is lower than room temperature. The first segment is generally termed the “hard block”, while the second segment is generally termed the “soft block”. The organic block copolymers used as coatings in sensors encompass diblock copolymers, triblock copolymers, graft block copolymers, star block copolymers and alternating block copolymers. Both the first and the second segments may themselves comprise copolymers that may be block copolymers, random copolymers, graft copolymers, star block copolymers, or the like, or combinations comprising at least one of the foregoing copolymers.

Suitable examples of polymers that can be used as the first segment are organic polymers that have a T_{g} greater than or equal to room temperature such as polyacetals, polyacrylics, polycarbonates polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or the like, or combinations comprising at least one of the foregoing organic polymers. The preferred organic polymers for the first segment are polyimides and polyetherimides.

Suitable examples of polymers that can be used as the second segment are organic polymers that have a T_{g} of less than room temperature such as polybutadienes, polyisoprenes, polysiloxanes, polychloroprenes, amorphous copolymers of ethylene and propylene, butyl rubbers, styrene-butadiene rubbers, nitrile rubbers, ethylene vinyl acetate rubbers, acrylic rubbers, fluorine rubbers, carboxynitroso rubbers, ethylene-vinylacetate rubbers, phosphazine rubbers, polysulfide rubbers, or the like, or combinations comprising at least one of the foregoing organic polymers. The preferred organic polymers for the second segment are polysiloxanes.

Functional groups that may be covalently bonded to the backbone of the first or second segments or to a group that is covalently bonded to the backbone of the first or second segments include bromo groups, chloro groups, iodo groups, fluoro groups, amino groups, hydroxyl groups, thio groups, phosphino groups, alkylthio groups, cyano groups, nitro groups, amido groups, carboxyl groups, aryl groups, heterocyclyl groups, ferrocenyl groups, heteroaryl groups, alkyl groups, aryl groups, alkaryl groups, aralkyl groups, fluoro substituted alkyl groups, ester groups, ketone groups, carboxylic acid groups, alcohol groups, alcohol groups comprising both primary and secondary groups, fluoro-substituted carboxylic acid groups, fluoro-alkyl-triflate groups, or the like, or a combination comprising at least one of the foregoing. The functional groups may be covalently bonded to the backbone of both segments but are preferably covalently bonded to the backbone of the first segment. A preferred block copolymer is one having a first segment that has fluorinated functional groups covalently bonded to the backbone while the second segment is a polydimethylsiloxane.

As stated above, the first segment is preferably a polyimide or a polyether imide oligomer or polymer formed by the reaction of a dianhydride compound and a diamine compound. The dianhydride compound may have the structure of formula (I) 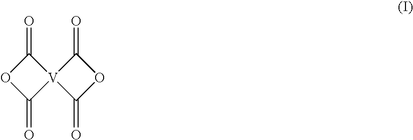
wherein V is a tetravalent linker selected from (a) substituted or unsubstituted, saturated, unsaturated or aromatic monocyclic and polycyclic groups having about 5 to about 50 carbon atoms, (b) substituted or unsubstituted, linear or branched, saturated or unsaturated alkyl groups having 1 to about 30 carbon atoms, and (c) combinations thereof, wherein the substitutions are ethers, epoxides, amides, esters, or combinations thereof. Preferred dianhydride compounds include those having the structure of formula (II) 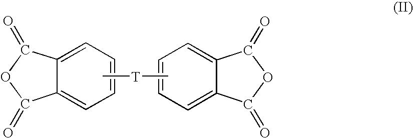
wherein the divalent T moiety bridges the 3,3′, 3,4′, 4,3′, or 4,4′ positions of the aryl rings of the respective aryl imide moieties of formula (I); T is —O— or a group of the formula —O—Z—O—; Z is a divalent radical selected from the following formulae (III) 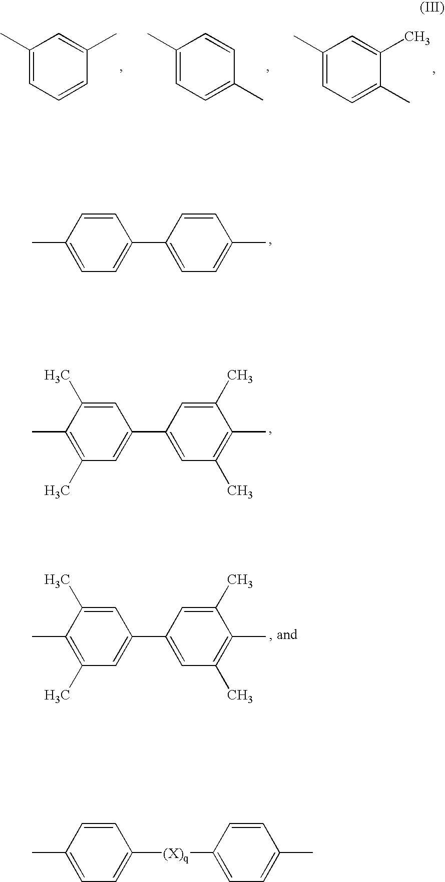
wherein X is a member selected from divalent radicals of the formulae (IV) 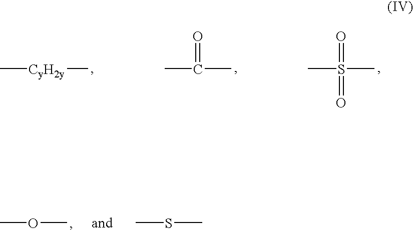
wherein y is an integer of 1 to about 5, and q is 0 or 1. In one embodiment, the dianhydride compound comprises bisphenol A dianhydride (BPADA), which consists of one or more isomers having the structure of formula (V)

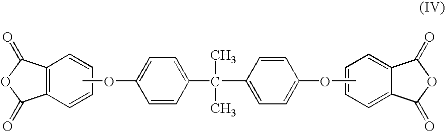

In another embodiment, the dianhydride compound comprises 4,4′-oxy-diphthalic anhydride (ODPA), which consists of one or more isomers having the structure of formula (VI)

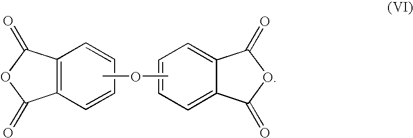

In another embodiment the dianhydride compound comprises hexafluorodipropane dianhydride (6FDA), which comprises one of more isomers having the structure of formula (VII)

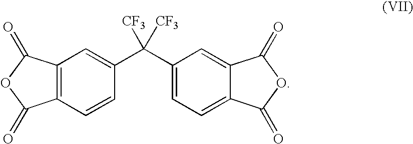

In yet another embodiment, the dianhydride compound comprises 4,4′-bisphthalic anhydride (BDA) which comprises one of more isomers having the structure of formula (VIII)

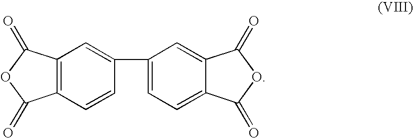

In yet another embodiment, the dianhydride compound comprises one of more isomers having the structure of formula (IX) (IX).

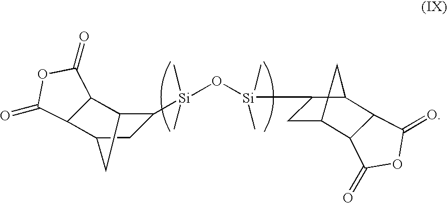

In yet another embodiment, the dianhydride is 3,4,9,10-perylenetetracarboxylic dianhydride having the structure of formula (X)

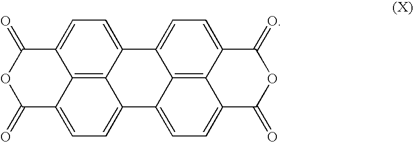

In yet another embodiment, the dianhydride is a pyromellitic dianhydride having the structure of formula (XI)

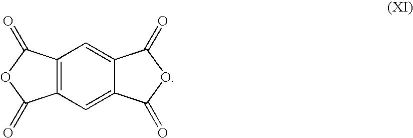

In another embodiment, the dianhydride compound comprises a combination of any of the dianhydride compounds of formulas (V) to (XI).

The diamine compound may have the structure of formula (XII)
H₂N—R—NH₂ (XII)
wherein R is a divalent organic radical selected from (a) aromatic hydrocarbon radicals having 6 to about 20 carbon atoms and halogenated derivatives thereof, (b) alkylene radicals having 2 to about 20 carbon atoms, (c) cycloalkylene radicals having 3 to about 20 carbon atoms, and (d) divalent radicals of the general formula (XIII) 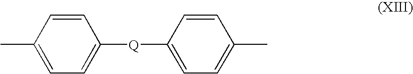
where Q is a covalent bond or a member selected from the formulae 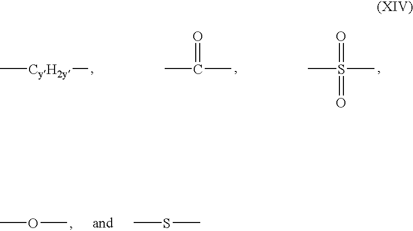
where y′ is an integer from 1 to about 5. Specific diamine compound include, for example, m-phenylenediamine, p-phenylenediamine, bis(4-aminophenyl)methane, bis(4-aminophenyl) ether, hexamethylenediamine, 1,4-cyclohexanediamine, diaminodiphenylsulfones such as 4,4′-diaminodiphenylsulfone, and the like, and mixtures thereof. In one embodiment, the diamine compound comprises ortho-, meta- and para-phenylenediamine (m-PD) shown in the formulas (XV), (XVI) and (XVII) respectively.

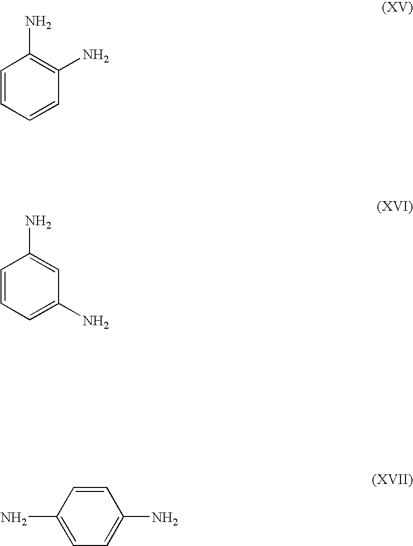

In another embodiment, the diamine compound comprises a bisphenol A (BPA) diamine, which comprises one or more isomers having the structure of formula (XVIII)

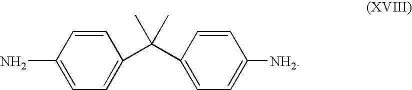

In yet another embodiment, the diamine compound comprises diaminodiphenylsulfone (DDS), which consists of one or more isomers having the structure of formula (XIX) 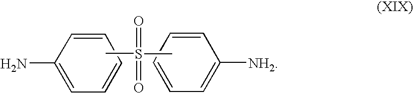
In another embodiment, the diamine compound comprises m-PD and DDS.

The reaction of the dianhydride compound and diamine compound may, optionally, take place in the presence of a so-called chain stopper. Chain stoppers capable of reacting with free amine end groups on the oligomer or the polyimide include, for example, phthalic anhydride. Chain stoppers capable of reacting with free anhydride end groups on the oligomer or the polyimide include, for example, aniline and substituted anilines.

The preferred second segment is for the organic block copolymer is polysiloxane having the structure of formula (XX) 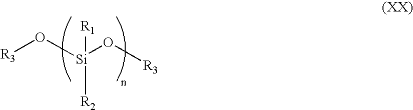
where R₁ and R₂ are functional groups that are the same or different and are alkyl, aryl, aryloxy, aralkyl, alkaryl, cyclohexyl, phenyl, ketone, fluoro substituted alkyl, ester, ketone, thiol, aldehyde, carboxyl, alcohol, fluoro alcohol, fluoro-substituted carboxylic acid, fluoro-alkyl-triflate, hydroxyl, alkenyl, or the like. Functional groups may also be covalently bonded to a group that is covalently bonded to the backbone the second segments. A preferred R₂ group has the structure of formula (XXI) 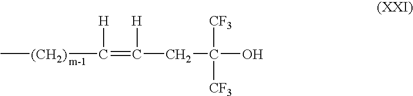
where m is 1 to 4 and n is an integer greater than or equal to about 1. It is preferable for R₁ and R₂ to hydrogen bond with the analyte. The ability to hydrogen bond affects the sensitivity and selectivity of the organic block copolymer and the analyte and hence the partition coefficient. The functional groups on the attached to the polymer backbone may be varied by design using the combinatorial methodology in order to improve selectivity sensitivity towards certain analytes. R₃ in the formula (XX) is a reactive species so as to facilitate the formation of the block copolymers and may be hydroxyl, diamine, alkoxy, or the like.

The reaction of the diamine compound and dianhydride compound takes place in a solvent. Suitable solvents include halogenated aromatic solvents, halogenated aliphatic solvents, non-halogenated aromatic solvents, non-halogenated aliphatic solvents, and mixtures thereof. Halogenated aromatic solvents are illustrated by ortho-dichlorobenzene (ODCB), chlorobenzene, and the like, and mixtures thereof. Non-halogenated aromatic solvents are illustrated by toluene, xylene, anisole, and the like, and mixtures thereof. Halogenated aliphatic solvents are illustrated by methylene chloride, chloroform, 1,2-dichloroethane, and the like, and mixtures thereof. Non-halogenated aliphatic solvents are illustrated by ethanol, acetone, ethyl acetate, and the like, and mixtures thereof. In one embodiment, the solvent comprises a halogenated aromatic solvent. In one embodiment, the solvent comprises ortho-dichlorobenzene.

Reaction of the dianhydride compound with the diamine compound in the solvent generates an oligomer mixture. In one embodiment, the oligomer mixture comprises amic acid repeating units having the structure of formula (XXII) 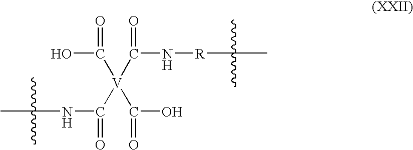
wherein V is a tetravalent linker selected from (a) substituted or unsubstituted, saturated, unsaturated or aromatic monocyclic and polycyclic groups having about 5 to about 50 carbon atoms, (b) substituted or unsubstituted, linear or branched, saturated or unsaturated alkyl groups having 1 to about 30 carbon atoms, and (c) combinations thereof, wherein the substitutions are ethers, epoxides, amides, esters, or combinations thereof. In the structure immediately above, R is a substituted or unsubstituted divalent organic radical selected from (a) aromatic hydrocarbon radicals having about 6 to about 20 carbon atoms or halogenated derivatives thereof, (b) straight or branched chain alkylene radicals having about 2 to about 20 carbon atoms; (c) cycloalkylene radicals having about 3 to about 20 carbon atoms, and (d) divalent radicals of the general formula (XXIII) 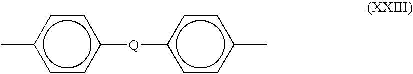
wherein Q is a divalent moiety selected from —O—, —S—, —C(O)—, —SO₂—, CyH_{2y}—, and halogenated derivatives thereof, wherein y is an integer from 1 to 5. Because the rate of polymerization (i.e., chain growth) may be similar to the rate of imidization, the oligomer may comprise imidized repeat units. Thus, in addition to the amic acid repeat units described above, the oligomer may, optionally, further comprise at least one imidized repeating unit having a structure selected from the formula (XXIV) 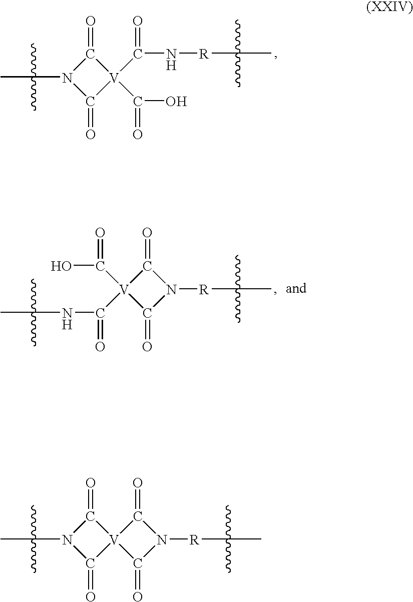
wherein V and R are as defined above.

An oligomer is herein defined as comprising a number average of at least two repeating units. The oligomer may preferably comprise a number average of at least greater than or equal to about 3 repeating units, more preferably at least greater than or equal to about 4 repeating units, even more preferably greater than or equal to about 5 repeating units. In one embodiment, the oligomer comprises repeating units having the structure of formula (XXV)

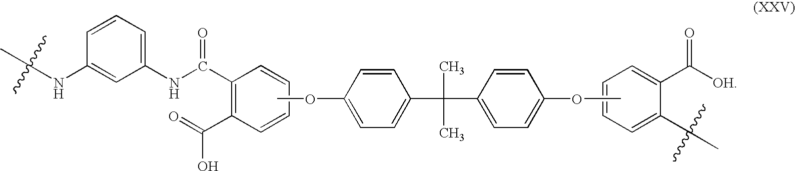

Such units may be derived, for example, from oligomerization of BPADA and m-PD in a suitable solvent. In another embodiment, the oligomer comprises repeating units having the structure (XXVI)

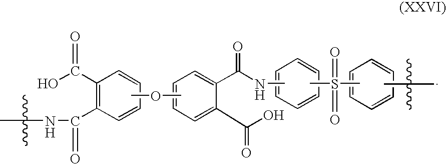

Such units may be derived, for example, from oligomerization of OPD and DDS in a suitable solvent. In another exemplary embodiment, the oligomer is formed from co-oligomerization of at least three monomers selected from bisphenol A dianhydride, 4,4′-oxy-diphthalic anhydride, meta-phenylenediamine, and diaminodiphenylsulfone.

The oligomer mixture may comprise about 10 to about 95 wt % of the solvent. Within this range, the solvent content is preferably of at least about 20, more preferably at least about 30, still more preferably at least about 40 wt %. Also within this range, the solvent content is preferably up to about 90, more preferably up to about 80, still more preferably up to about 70 wt %. The oligomer mixture is then reacted to form a polyimide.

There is no particular molecular weight limit on the polyimide, except that it has a higher molecular weight than the oligomer. In one embodiment, the polyimide comprises a number average of repeating units of greater than or equal to about at least two, preferably greater than or equal to about three, more preferably greater than or equal to about 4, still more preferably greater than or equal to about five repeating units greater than the number average of repeating units in the oligomer.

In one embodiment, the polyimide comprises a number average of repeating units at least 1.2, preferably at least 1.3, more preferably at least 1.4, still more preferably at least 1.5 times greater than the number average of repeating units in the oligomer. Similarly, in one embodiment, the ratio of the polyimide weight average molecular weight to the oligomer weight average molecular weight is about 1.2 to about 10. Within this range, the ratio is at least about 1.5, more preferably at least about 1.8. Also within this range, the ratio is up to about 8, more preferably up to about 6, still more preferably up to about 4.

In one embodiment, the polyimide has a polydispersity index less than about 4, preferably less than about 3, more preferably less than about 2.5. The polydispersity index is the ratio of the weight average molecular weight to the number average molecular weight. The molecular weight characteristics of the oligomer and the polyimide may be determined by methods known in the art such as, for example, gel permeation chromatography using appropriate standards.

The second segment may then be added to the polyimide and the reaction continued to form the organic block copolymer. The solvent is then removed from the organic block copolymer and the remaining film is then tested for use as a coating on a sensor. The first segment generally comprises about 5 to about 95 wt % of the total weight of the organic block copolymer. Similarly the second segment comprises about 5 to about 95 wt % of the total weight of the organic block copolymer.

It is generally desirable for the organic block copolymer produced by the method to comprise less than 1,000, preferably less than 500, more preferably less than 250, still more preferably less than 100, even more preferably less than 50 parts per million by weight of residual solvent. It is also generally desirable for the organic block copolymer to be semi-crystalline.

It is generally desirable for the first segment and/or the second segment to have a number average molecular weight of about 1,000 g/mole to about 1,000,000 g/mole. Within this range a number average molecular weight of greater than or equal to about 2,000, preferably greater than or equal to about 3,000 g/mole and more preferably 4,000 g/mole is desirable. Also desirable within this range is a number average molecular weight of less than or equal to about 500,000, preferably less than or equal to about 250,000, and more preferably less than or equal to about 150,000 g/mole. The molecular weights of the first segment may be greater than, equal to, or less than the molecular weight of the second segment.

In one embodiment, the organic reactants 14 are deposited onto the surface 16 of the substrate 18 and are reacted at the appropriate conditions to form a plurality of coatings 20. The organic reactants 14 are delivered in varying concentrations onto the surface 16 of the substrate 18 in order to form a plurality of coatings 20 having different block sizes, different weight fractions of one segment to another, different functional groups, and the like. After removing the unreacted species, such as, but not limited to the optional solvent, from the reactants, the coating formed on the substrate in the form of a film is subjected to testing. The unreacted species including the solvent may be removed either before, during or after the reaction or at all times during the course of the reaction as desired.

The substrate 18 upon which the plurality of coatings 20 are formed may be an acoustic wave device or a QCM device. The plurality of coatings 20 are then tested for their ability to detect analytes. The plurality of coatings 20 may either be exposed to a fixed concentration of a particular analyte or to varied concentrations of analytes. In one method of analysis, physical or chemical changes in the plurality of coatings 20 upon exposure to the analyte alters the sensor's (i.e., the acoustic wave device or the QCM device) mechanical oscillation frequencies, and thus permit the analyte to be detected by the sensor. The sensor's changing frequencies result from the interaction of organic block copolymer coating with the analyte. Accordingly, various analytes can be detected by a sensor when the nature of the interaction between the organic block copolymer and the analyte is determined.

In one example of such an interaction between the analyte and the organic block copolymer coating disposed upon a substrate 18, the analyte sorbs into the organic block copolymer. This causes an increase in mass that is detected by the substrate 18, which comprises either an acoustic wave device or a QCM device. If there is no interaction between the analyte and the organic block copolymer, then the coating mass remains unchanged. An altered frequency may result from a changed organic block copolymer coating mass. An increased coating mass lowers a frequency at which the crystal oscillates. Thus, the presence of the analyte perturbs the oscillation of the sensor when the mass of the polymeric film changes and thus the analyte can be detected. Thus the change in the weight of the coating can be used to determine the presence and concentration of the analyte.

In general, the coating may have a thickness of about 0.1 nanometers to about 100 micrometers. Within this range, it is generally desirable to have a thickness of greater than or equal to about 1 nanometer, and preferably greater than or equal to about 10 nanometers. Also desirable within this range is a thickness of less than or equal to about 10 micrometers, and more preferably less than or equal to about 1 micrometer. It is also desirable for the coating to have a partition coefficient of greater than or equal to about 10⁴, preferably greater than or equal to about 10⁵, preferably greater than or equal to about 5×10⁵, and more preferably greater than or equal to about 10⁶.

In one embodiment, the substrate 18 comprising the sensor assembly, is connected to a monitoring system that provides near real-time or real-time information for at least one of detection, analysis, and evaluation. The terms “real-time” and “near real-time” mean that any delays from the time of detecting and sensing and the results being made available are minimal. For example, the delays may be on the order of minutes, and possibly a few seconds, or longer. The delay period may vary as long as the information is considered relevant and of value to the interested party, regardless of the delay. Also, the term real time can mean the time required for a user of the sensor assembly to obtain the detection information as long as the user desires it.

In one embodiment, at least one optional chemically sensitive organic dye is incorporated into the organic block copolymer coatings prior to, during, or after synthesis. The dye molecule can either be covalently bonded to the organic block copolymer or it can exist within the matrix of the coating 20 without being covalently bonded. Such dyes generally undergo changes in their optical characteristics such as absorbance or luminescence as a function of absorption of the analyte. Suitable examples of such dyes are anthanthrone, anthraquinone, monoazoarylamide, benzimidazolone, diketopyrollopyrolle, dioxazine, disazo condensation compounds, disazo diarylide, indanthrone, isoindoline, isoindolinone, metal complexes, mono azo salt, naphthol beta, naphthol lakes, perinone, perylene, phthalocyanine, pyranthrone, quinacridone, quinophthalone, or the like, or combinations comprising at least one of the foregoing dyes.

The combinatorial method of developing coatings for sensors is advantageous in that accelerates the process of discovery of families of coatings for the detection of analytes. It also accelerates the process of optimization of a given coating for purposes of detecting a specific analyte. The coatings developed by this method can be used in a variety of sensors that operate as acoustic wave detectors or quartz crystal microbalance detectors. The acoustic wave detectors having the organic block copolymer coatings can be advantageously used in a variety of configurations such as thickness-shear mode (TSM), surface acoustic wave (SAW), acoustic plate mode (APM), flexural plate wave (FPW), and surface transverse wave (STW) to detect a wide variety of analytes.

A wide variety of analytes may be analyzed by the disclosed sensors so long as the subject analyte is capable generating a differential response across a plurality of sensors of the array. Analyte that may be detected include broad ranges of chemical classes of organics such as alkanes, alkenes, alkynes, dienes, alicyclic hydrocarbons, arenes, alcohols, ethers, ketones, aldehydes, carbonyls, carbanions, polynuclear aromatics and derivatives of such organics, e.g., halide derivatives, biomolecules such as sugars, isoprenes and isoprenoids, fatty acids, or the like. Accordingly, commercial applications of the sensors include environmental toxicology and remediation, biomedicine, materials quality control, food and agricultural products monitoring, or the like.

Exemplary analytes that can be detected by the organic block copolymer coatings are liquid aprotic polar solvents such as propylene carbonate, ethylene carbonate, butyrolactone, acetonitrile, benzonitrile, nitromethane, nitrobenzene, sulfolane, dimethylformamide, N-methylpyrrolidone, or the like, or combinations comprising at least one of the foregoing solvents. Polar protic solvents such as water, methanol, acetonitrile, nitromethane, ethanol, propanol, isopropanol, butanol, or combinations comprising at least one of the foregoing polar protic solvents, or the like, or combinations comprising at least one of the foregoing polar protic solvents may also be detected. Other non-polar solvents such a benzene, toluene, methylene chloride, carbon tetrachloride, hexane, diethyl ether, tetrahydrofuran, or the like, or combinations comprising at least one of the foregoing non-polar solvents may also be detected.

The analyte is a fluid composition and may be in liquid or vapor form. The fluid composition can be any type of fluid such as a solution of one fluid in another, particulates dissolved in or suspended in a liquid, a vapor containing suspended particles, or the like.

The detection capabilities of the coatings are dependent upon the partition coefficients. It is generally desirable for a sensor having the organic block copolymer coatings to detect analytes at concentrations of less than 1 part 10⁴ parts, preferably less than 1 part per 10⁵ parts, more preferably less than 1 part per 5×10⁵ parts, and most preferably less than 1 part per 10⁶ parts.

The following examples, which are meant to be exemplary, not limiting, illustrate compositions and methods of manufacturing of some of the various embodiments of the combinatorial libraries and the plurality of organic block copolymer coatings described herein.

### EXAMPLES

### Example 1

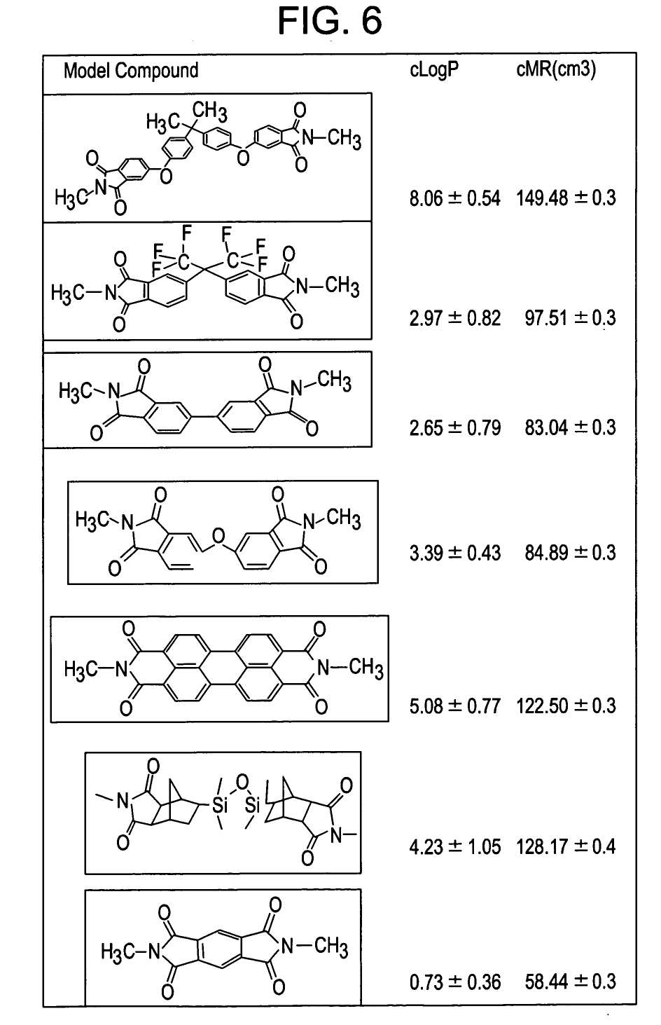

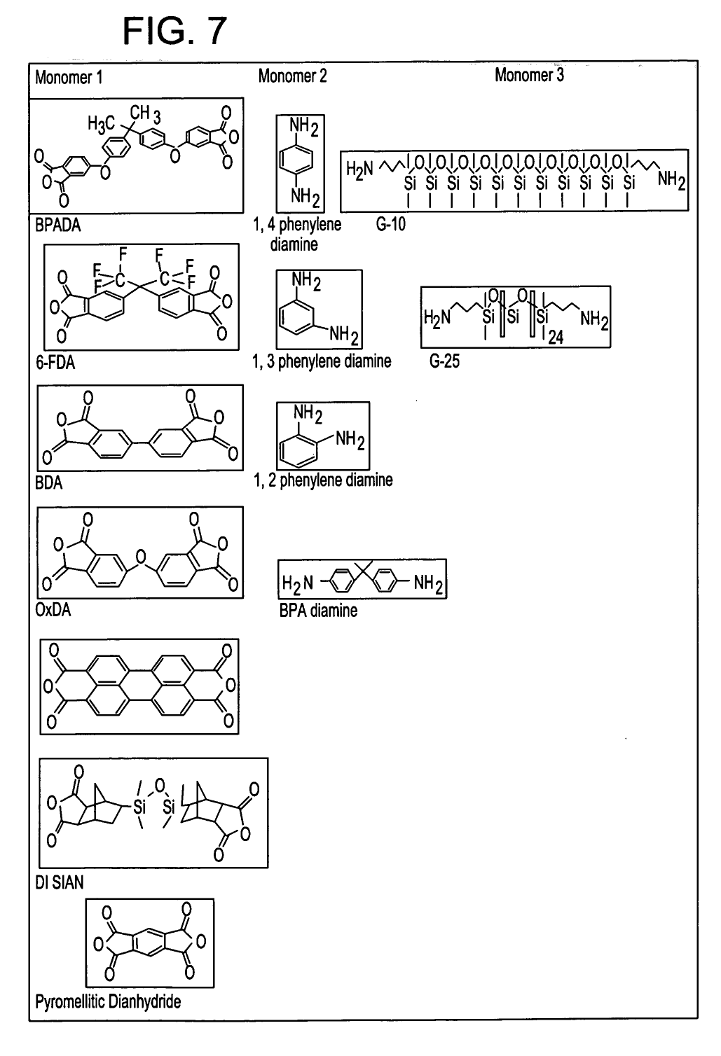

This example was undertaken to determine the ability of a combinatorial library to develop coatings that could be used in the detection of analytes. The organic block copolymer was a polyimide-polysiloxane block copolymer having the reactants as shown in the FIGS. 6 and 7. The reactants as shown in FIGS. 6 and 7 are dianhydrides, diamines and polysiloxanes. The dianhydrides shown in the FIG. 6 were selected based upon the octanol-water partition coefficient cLogP and the molar refractivity cMr.

The synthesis of the organic block copolymer was conducted via a stepwise imidization process to form an amic acid intermediate. The amic acid was then mixed with the polysiloxane copolymer and polymerized to form the polyimide-polysiloxane block copolymer.

In order to evaluate the performance of the polyimide-polysiloxane block copolymers, the copolymers were applied as a thin film onto the surface of a transducer of a thickness shear mode (TSM) acoustic wave sensor. The change in polymer mass was monitored upon exposure to analyte vapors. An AT-cut quartz crystal with gold electrodes was used was used as the sensor substrate. The term AT-cut refers to the way a piece of quartz is cut to produce the individual crystal blanks. In an AT-cut crystal, the quartz is cut at an oblique angle with respect to one crystal axis. These crystals oscillate in the thickness-shear mode with a fundamental frequency of 10 MHz. The coating deposition the block copolymer was dissolved in chloroform and applied to both surfaces of the crystal.

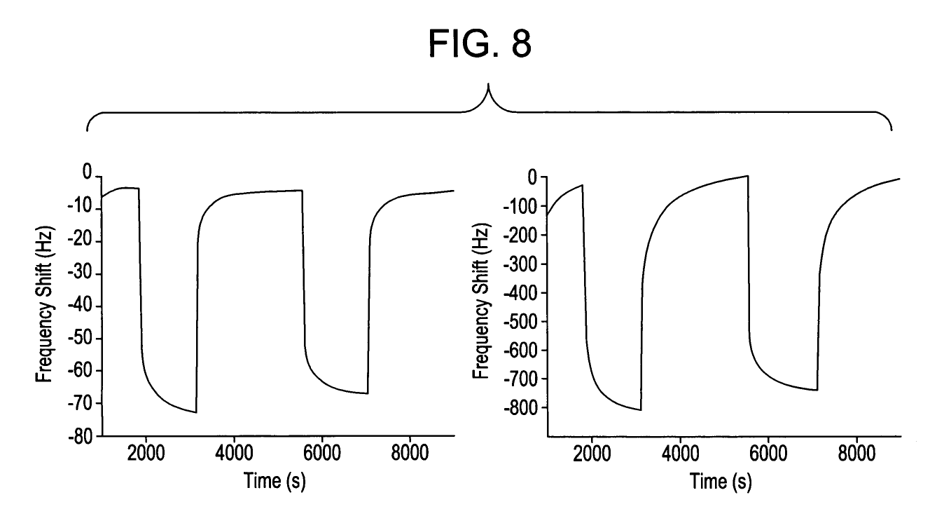

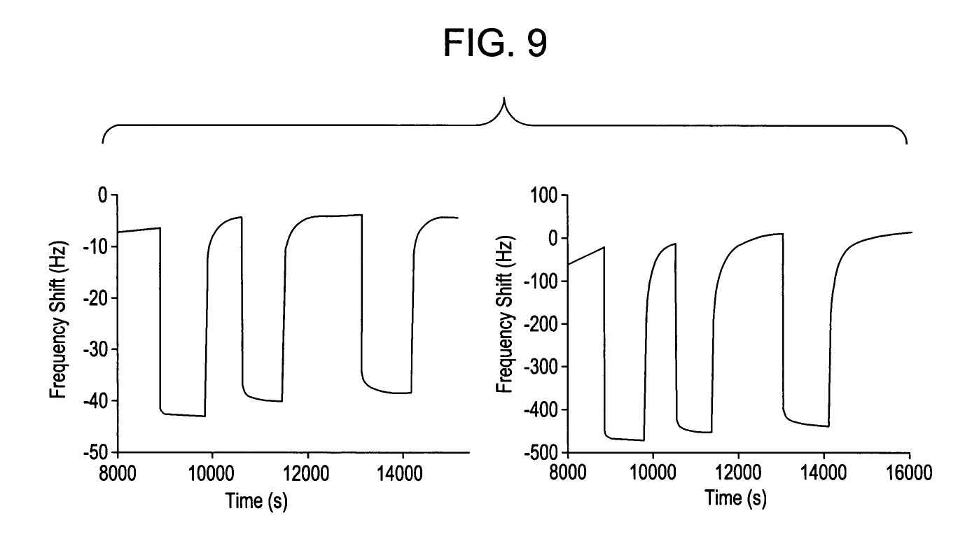

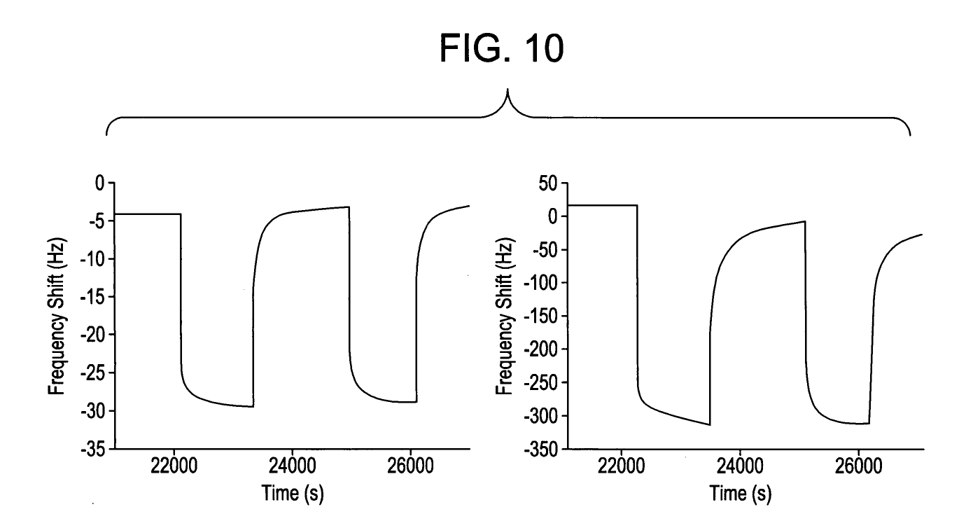

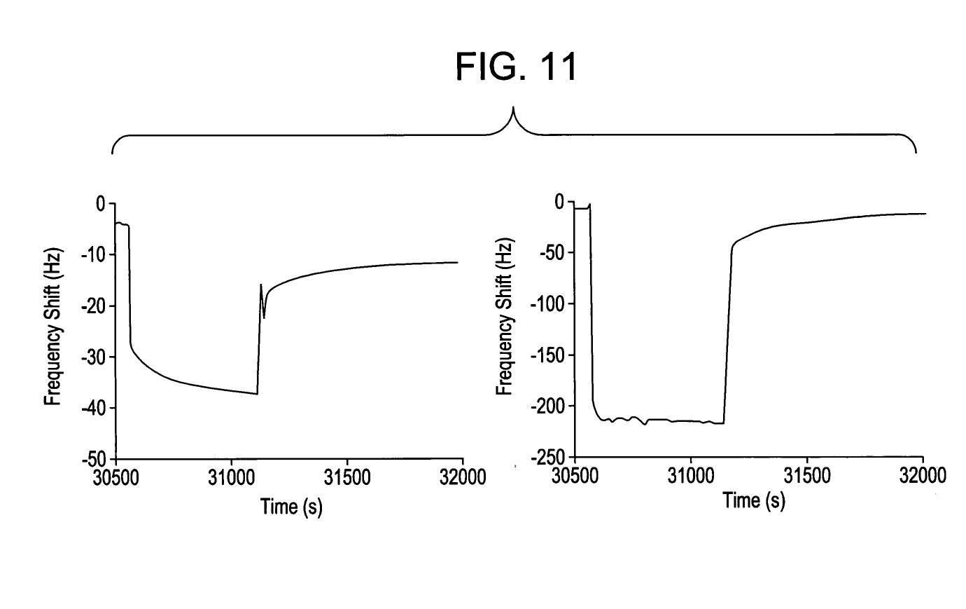

Coated crystals were arranged in an array and exposed to different concentrations of solvent vapors. The resonant oscillation frequency of the array of transducers was monitored using 225-MHz Universal Counters model HP 53 132A, commercially available from Hewlett Packard, Santa Clara, Calif. as a function of time. Data acquisition was performed with a laptop computer using a program written in LabVIEW commercially available from National Instruments, Austin, Tex. Upon exposure of the TSM sensor array to varying concentrations of vapors, the signal change was recorded. Sensor response was observed to be completely reversible and rapid (less than a minute) indicating the attractive rapid sorption/desorption characteristics of the material composition. Plots showing the dynamic response upon introduction of different organic vapors are presented in FIGS. 8-12 for pentachloroethylene (PCE), trichloroethylene (TCE), toluene, and water vapor, respectively. These vapors were selected as model vapors to cover both polar and non-polar vapors. FIG. 8 is a graphical representation of the dynamic response of sensor 1 (left) and sensor 2 (right) upon exposure to 106 parts per million (ppm) of PCE and dry nitrogen. FIG. 9 is a graphical representation of the dynamic response of sensor 1 (left) and sensor 2 (right) upon exposure to 103 ppm of TCE and dry nitrogen. FIG. 10 is a graphical representation of the dynamic response of sensor 1 (left) and sensor 2 (right) upon exposure to 100 ppm of toluene and dry nitrogen. FIG. 11 is a graphical representation of the dynamic response of sensor 1 (left) and sensor 2 (right) upon exposure to air of 37% relative humidity and dry nitrogen.

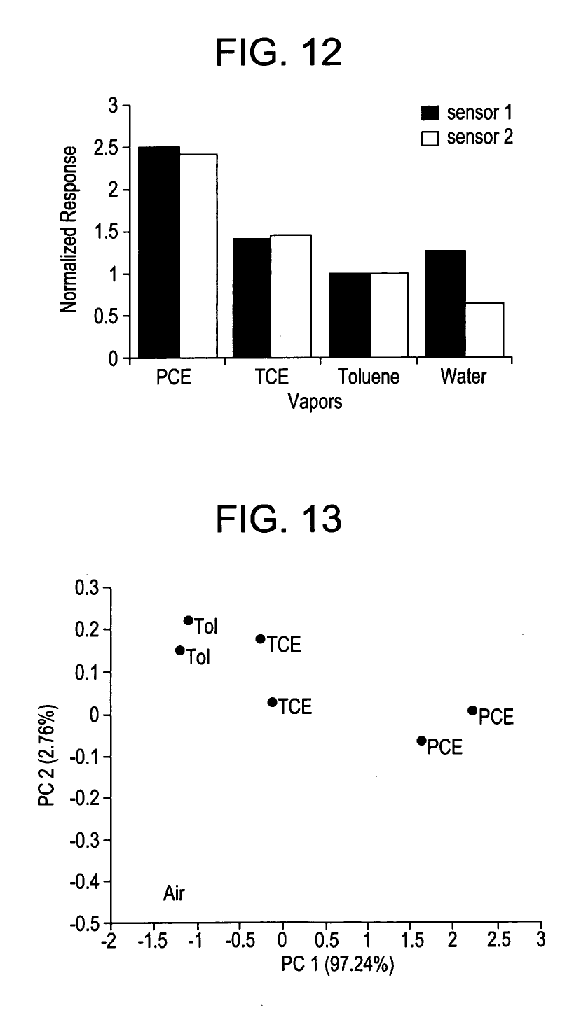

Determination of the selectivity in response of sensor array toward different vapors was performed by comparing responses of sensors normalized by the response to toluene as shown in FIG. 12.

To take into the account the responses of all sensors in the array, these responses were analyzed using multivariate analysis tools that provide a suitable pattern recognition approach. The goal of the pattern recognition was to find similarities and differences between chemical samples based on measurements made on the samples. Methods of pattern recognition include principal components analysis (PCA), hierarchical cluster analysis, soft independent modeling of class analogies, neural networks, and others. We have selected PCA because of its simplicity and ease of application to analysis of steady-state and dynamic data. Principal components analysis is a multivariate data analysis tool that projects the data set onto a subspace of lower dimensionality with removed co-linearity. PCA achieves this objective by explaining the variance of the data in terms of the weighted sums of the original variables with no significant loss of information. These weighted sums of the original variables are called principal components (PCs).

FIG. 13 depicts scores plots of the first two PCs. The scores plots show the relationship between the samples in the data set. Clearly, PCA differentiates responses of the sensor array toward toluene, TCE, PCE and air.

### Example 2

In this example, a polyimide-polysiloxane organic block copolymer was used as part of a sensor to determine the ability of the sensor to detect analytes. The polyimide component of the organic block copolymer was synthesized by reacting hexafluorodipropane dianhydride with meta-phenylenediamine and then copolymerizing the polyimide with a polysiloxane having 18 repeat units of the dimethylsiloxane. The block polyimide-polysiloxane organic block copolymer was compared with a control sample. The control sample was SILTEM® manufactured by the General Electric Company having 30 mole percent of polydimethylsiloxane. The block copolymer as well as the control were tested in a manner similar to that in Example 1.

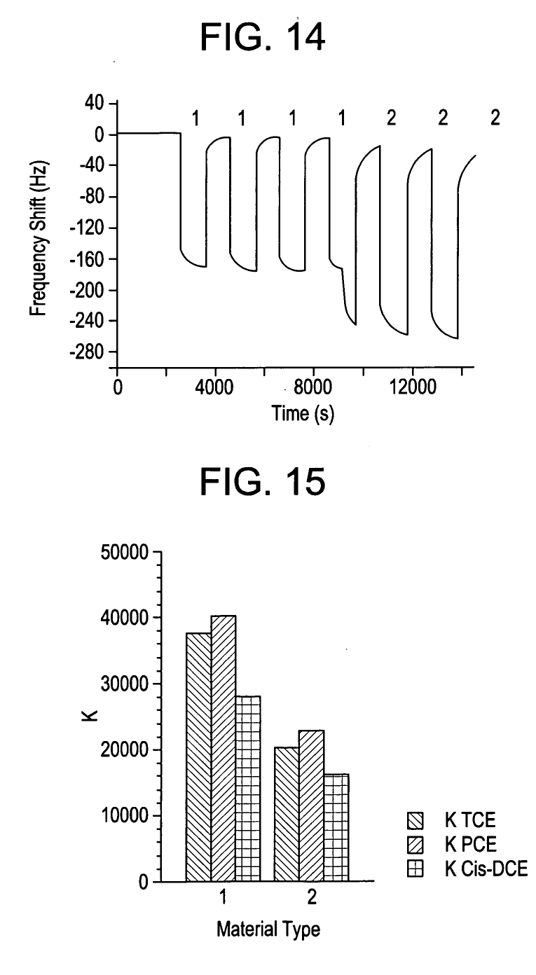

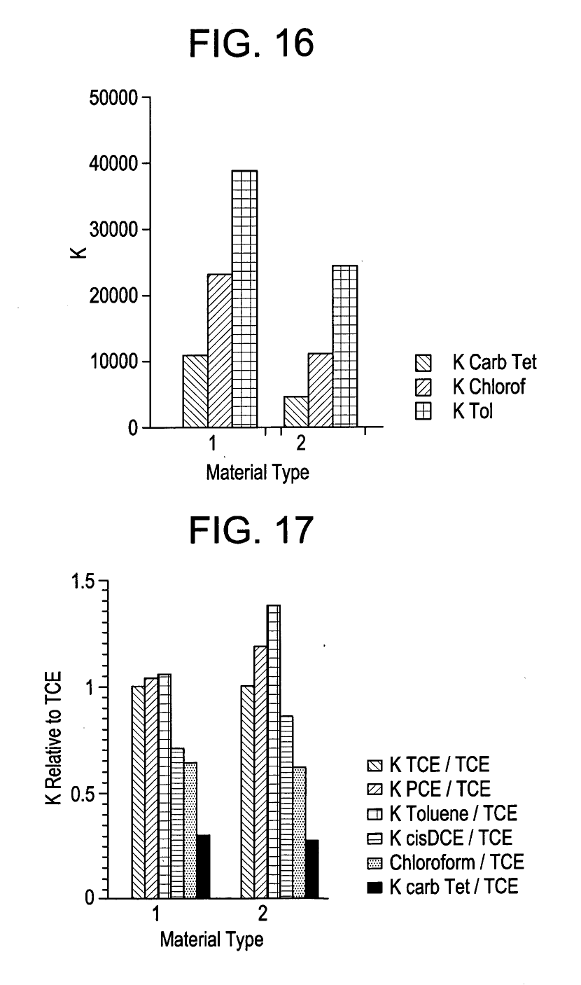

The block copolymer was subjected to the following analytes: TCE, PCE, toluene, cis-dichloroethylene (cis-DCE), chloroform, toluene and carbon tetrachloride. The results are shown in the FIGS. 14-17. FIG. 14 is a graphical representation of the dynamic response of 6FDA-mPDA-PDMS organic block copolymer produced using combinatorial approach upon exposure to 10 ppm of TCE (1) and 10 ppm of PCE (2) and dry nitrogen. FIG. 15 is a graphical representation of the partition coefficients of a control sensor material (1) and the 6FDA-mPDA-PDMS organic block copolymer (2) for different analyte vapors such as TCE, PCE and cis-dichloroethylene (cis-DCE). FIG. 17 is a graphical representation of the partition coefficients of a control sensor material (1) and 6FDA-mPDA-PDMS organic block copolymer (2) for different analyte vapors such as carbon tetrachloride (Carb Tet), chloroform (Chlor) and toluene (Tol). FIG. 18 is a graphical representation of the partition coefficients relative to the partition coefficient of TCE for the control sensor material (1) and 6FDA-mPDA-PDMS organic block copolymer (2) for different analyte vapors such as TCE, PCE, toluene, cis-DCE, chloroform, and carbon tetrachloride.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A system for creating a combinatorial coating sensor library comprising:
a delivery mechanism in fluid communication with a source of organic polymer reactants and a substrate having at least one delivery area;
a reaction source operative to apply at least one reactive environment to the delivery area; and
a controller in communication with the delivery mechanism in a manner effective to apply a plurality of organic reactants to the substrate, and further wherein the controller is in communication with the reaction source in a manner effective to react at least one of the plurality of organic reactants on the substrate into an organic block copolymer coating.

2. The system of claim 1, wherein the substrate comprises a detector for analytes.

3. The system of claim 1, wherein the detector is an acoustic wave device or a quartz crystal microbalance device.

4. The system of claim 1, wherein the acoustic wave operates in the thickness-shear mode, surface acoustic wave mode, acoustic plate mode, flexural plate wave mode, and surface transverse wave mode.

5. The system of claim 1, wherein the organic block copolymer has the structure of formula 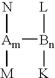
wherein A represents a first segment comprising an organic polymer having a glass transition greater than or equal to about room temperature and B represents a second segment comprising an organic polymer having a glass transition less than room temperature, K, L, M and N are the same or different and represent functional groups.

6. The system of claim 5, wherein the first segment has a glass transition greater than or equal to about 23° C. and wherein the second segment has a glass transition temperature of less than 23° C.

7. The system of claim 6, wherein the first segment is an organic polymer, wherein the organic polymer is polyacetal, polyacrylic, polycarbonate, polystyrene, polyester, polyamide, polyamideimide, polyarylate, polyarylsulfone, polyethersulfone, polyphenylene sulfide, polyvinyl chloride, polysulfone, polyimide, polyetherimide, polytetrafluoroethylene, polyetherketone, polyether etherketone, polyether ketone ketone, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitrites, polyvinyl esters, polysulfonates, polysulfides, polythioesters, polysulfones, polysulfonamides, polyureas, polyphosphazenes, polysilazanes, or a combination comprising at least one of the foregoing first segments.

8. The system of claim 6, wherein the second segment is an organic polymer, wherein the organic polymer is a polybutadiene, polyisoprene, polysiloxane, polychloroprene, amorphous copolymers of ethylene and propylene, butyl rubber, styrene-butadiene rubber, nitrite rubber, ethylene vinyl acetate rubber, acrylic rubber, fluorine rubber, carboxynitroso rubber, ethylene-vinylacetate rubber, phosphazine rubber, polysulfide rubber, or a combination comprising at least one of the foregoing organic polymers.

9. The system of claim 6, wherein the first segment is a polyimide and the second segment is a polysiloxane.

10. The system of claim 9, wherein the polyimide is formed by the reaction of a dianhydride with a diamine.

11. The system of claim 1, wherein the organic block copolymer coating has a partition coefficient of greater than or equal to about 10⁴.

12. The system of claim 1, wherein the organic block copolymer coating has a partition coefficient of greater than or equal to about 10⁵.

13. The system of claim 1, wherein the sensor library comprises at least one organic block copolymer that provides for detecting an analyte, and wherein the analyte is present in an amount of less than or equal to about 1 part per million parts.

14. The system of claim 1 wherein the sensor library comprises at least one organic block copolymer that provides for detecting an analyte, and wherein the analyte is present in an amount of less than or equal to about 1 part per billion parts.

15. The system of claim 5, wherein the functional groups are bromo groups, chloro groups, iodo groups, fluoro groups, amino groups, hydroxyl groups, thio groups, phosphino groups, alkylthio groups, cyano groups, nitro groups, amido groups, carboxyl groups, aryl groups, heterocyclyl groups, ferrocenyl groups, heteroaryl groups, alkyl groups, aryl groups, alkaryl groups, aralkyl groups, fluoro substituted alkyl groups, ester groups, ketone groups, carboxylic acid groups, alcohol groups, fluoro-substituted carboxylic acid groups, fluoro-alkyl-triflate groups, or a combination comprising at least one of the foregoing functional groups.

16. A method for creating a sensor array comprising:
delivering a plurality of organic reactants in a quantity effective to form a block copolymer to at least one predefined region positioned within a delivery area of a substrate;
reacting the plurality of organic reactants in at least one of the predefined regions to form an organic block copolymer coating, and wherein the organic block copolymer coating in conjunction with at least the substrate is capable of detecting the presence of an analyte in amounts of less than 1 part per million parts.

17. The method of claim 16, wherein the substrate is a detector for analytes.

18. The method of claim 17, wherein the detector is an acoustic wave device or a quartz crystal microbalance device.

19. The method of claim 16, wherein the organic block copolymer comprises a first segment and a second segment.

20. The method of claim 19, wherein the first segment has a glass transition greater than or equal to about 23° C. and wherein the second segment has a glass transition temperature of less than 23° C.

21. The method of claim 20, wherein the first segment is an organic polymer, and wherein the organic polymer is polyacetal, polyacrylic, polycarbonate, polystyrene, polyester, polyamide, polyamideimide, polyarylate, polyarylsulfone, polyethersulfone, polyphenylene sulfide, polyvinyl chloride, polysulfone, polyimide, polyetherimide, polytetrafluoroethylene, polyetherketone, polyether etherketone, polyether ketone ketone, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes or a combination comprising at least one of the foregoing organic polymers.

22. The method of claim 20, wherein the second segment is an organic polymer, and wherein the organic polymer is a polybutadiene, polyisoprene, polysiloxane, polychloroprene, amorphous copolymers of ethylene and propylene, butyl rubber, styrene-butadiene rubber, nitrile rubber, ethylene vinyl acetate rubber, acrylic rubber, fluorine rubber, carboxynitroso rubber, ethylene-vinylacetate rubber, phosphazine rubber, polysulfide rubber, or a combination comprising at least one of the foregoing organic polymers.

23. The method of claim 20, wherein the first segment is a polyimide and the second segment is a polysiloxane.

24. The method of claim 20, wherein the polyimide is formed by the reaction of a dianhydride with a diamine.

25. The method of claim 16, wherein the organic block copolymer coating has a partition coefficient of greater than or equal to about 10⁵ towards at least one analyte.

26. The method of claim 16, wherein the coating has a thickness of about 0.1 nanometers to about 100 micrometers.

27. The method of claim 16, wherein the reacting is conducted by reaction source comprising ultraviolet radiation, infrared radiation, thermal radiation, microwave radiation, visible radiation, narrow-wavelength radiation, laser light, convectional heating, conductional heating, humidity, peroxides, catalysts, or combinations comprising at least one of the foregoing reaction sources.

28. The method of claim 16, further comprising removing at least one unreacted species.

29. A sensor comprising:
an organic block copolymer coating disposed upon a detection device; wherein the detection device comprises and acoustic wave device or a quartz crystal microbalance device and further wherein the organic block copolymer coating has a partition coefficient of greater than or equal to about 10⁵ towards at least one analyte.

30. The sensor of claim 29, wherein the coating has a thickness of about 0.1 nanometers to about 100 micrometers.

31. The sensor of claim 29, wherein the organic block copolymer coating comprises at least a first segment and a second segment.

32. The sensor of claim 31, wherein the first segment has a glass transition greater than or equal to about 23° C. and wherein the second segment has a glass transition temperature of less than 23° C.

33. The sensor of claim 32, wherein the first segment is an organic polymer, and wherein the organic polymer is polyacetal, polyacrylic, polycarbonate, polystyrene, polyester, polyamide, polyamideimide, polyarylate, polyarylsulfone, polyethersulfone, polyphenylene sulfide, polyvinyl chloride, polysulfone, polyimide, polyetherimide, polytetrafluoroethylene, polyetherketone, polyether etherketone, polyether ketone ketone, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or a combination comprising at least one of the foregoing organic polymers.

34. The sensor of claim 32, wherein the second segment is an organic polymer, and wherein the organic polymer is a polybutadiene, polyisoprene, polysiloxane, polychloroprene, amorphous copolymers of ethylene and propylene, butyl rubber, styrene-butadiene rubber, nitrile rubber, ethylene vinyl acetate rubber, acrylic rubber, fluorine rubber, carboxynitroso rubber, ethylene-vinylacetate rubber, phosphazine rubber, polysulfide rubber, or a combination comprising at least one of the foregoing organic polymers.

35. The sensor of claim 32, wherein the first segment is a polyimide and the second segment is a polysiloxane.

36. The sensor of claim 32, wherein the polyimide is formed by the reaction of a dianhydride with a diamine.

37. The sensor of claim 36, wherein the dianhydride has the structure of formula (II) 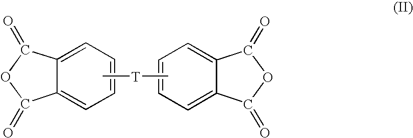
wherein the divalent T moiety bridges the 3,3′, 3,4′, 4,3′, or 4,4′ positions of the aryl rings; T is —O— or a group of the formula —O—Z—O—; Z is a divalent radical selected from the following formulae (III) 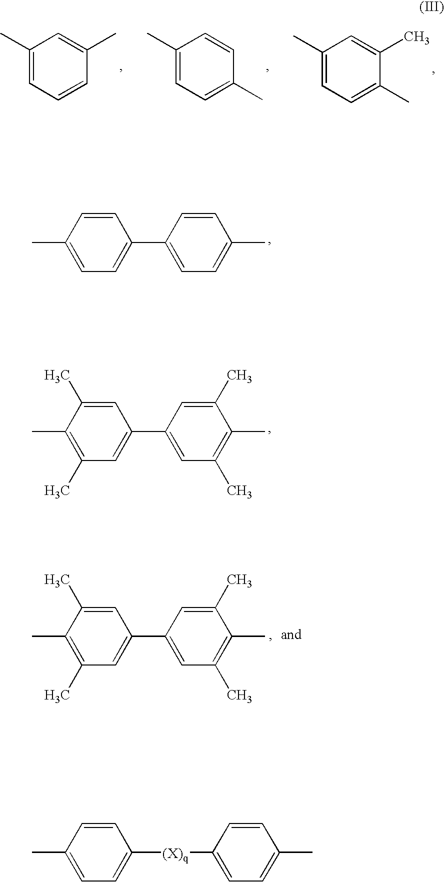
wherein X is a member selected from divalent radicals of the formulae (IV) 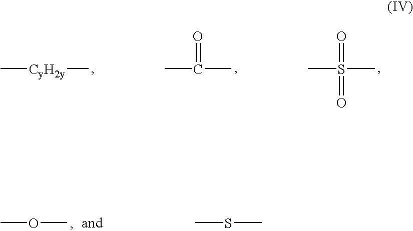
y is an integer of 1 to about 5, and q is 0 or 1.

38. The sensor of claim 36, wherein the dianhydride is bisphenol A dianhydride (BPADA), which consists of one or more isomers having the structure of formula (V), 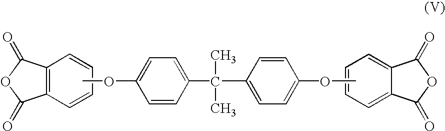
4,4′-oxy-diphthalic anhydride (ODPA), which consists of one or more isomers having the structure of formula (VI), 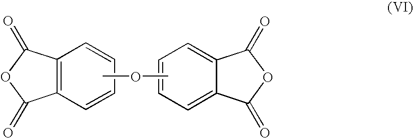
hexafluorodipropane dianhydride (6FDA), which comprises one of more isomers having the structure of formula (VII), 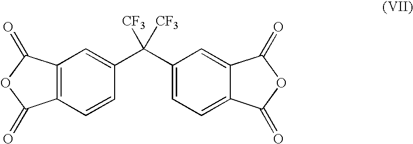
4,4′-bisphthalic anhydride (BDA), which comprises one of more isomers having the structure of formula (VIII), 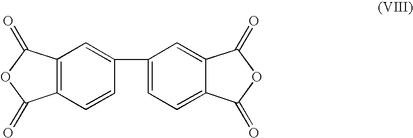
an isomer having the structure of formula (IX), 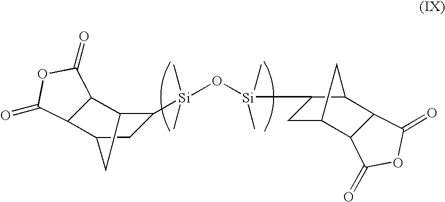
3,4,9,10-perylenetetracarboxylic dianhydride having the structure of formula (X), 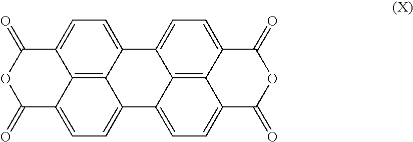
pyromellitic dianhydride having the structure of formula (XI) 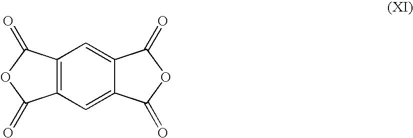
or a combination comprising at least one of the foregoing dianhydrides.

39. The sensor of claim 36, wherein the diamine has the structure of the formula (XII)
H₂N—R—NH₂ (XII)
wherein R is a divalent organic radical selected from (a) aromatic hydrocarbon radicals having 6 to about 20 carbon atoms and halogenated derivatives thereof, (b) alkylene radicals having 2 to about 20 carbon atoms, (c) cycloalkylene radicals having 3 to about 20 carbon atoms, and (d) divalent radicals of the general formula (XIII) 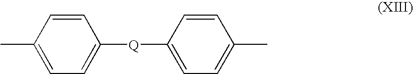
where Q is a covalent bond or a member selected from the formulae 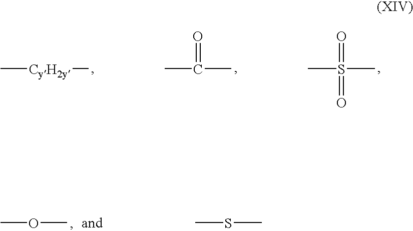
where y′ is an integer from 1 to about 5.

40. The sensor of claim 36, wherein the diamine is m-phenylenediamine, p-phenylenediamine, bis(4-aminophenyl)methane, bis(4-aminophenyl)ether, hexamethylenediamine, bisphenol A diamine, 1,4-cyclohexanediamine, diaminodiphenylsulfones or a combination comprising at least one of the foregoing diamines.

41. The sensor of claim 29, wherein the organic block copolymer coating is semi-crystalline.
